(19) United States
(12) Patent Application Publication
(10) Pub. No.: US 2025/0390408 A1
(43) Pub. Date: Dec. 25, 2025

(54) PERFORMANCE MONITORING

(71) Applicant: Arm Limited, Cambridge (GB)

(72) Inventors: Lorenzo DI GREGORIO, Gauting (DE); Zuning LUO, Austin, TX (US)

(21) Appl. No.: 18/753,562

(22) Filed: Jun. 25, 2024

(51) Int. Cl. G06F 11/34; G06F 11/30

(52) U.S. Cl. CPC G06F 11/3409; G06F 11/3024

(57) ABSTRACT

Performance monitoring circuitry is provided for monitoring processing system performance. The performance monitoring circuitry comprises event count storage circuitry to store a plurality of event count values; event monitoring hardware circuitry to maintain the event count values stored in the event count storage circuitry based on monitoring of events occurring in a processing system; and derived event count calculating circuitry to perform an event count combination operation to update the event count storage circuitry to specify a derived event count value which depends on a combination of at least two event count values obtained from the event count storage circuitry. The event count combination operation performed by the derived event count metric calculating circuitry is programmable based on control information set in response to directives provided by a programming agent.

### BACKGROUND

### Technical Field

The present technique relates to the field of processing systems.

### Technical Background

A processing system may have performance monitoring circuitry for monitoring processing system performance. The performance monitoring circuitry can include event counters for counting occurrences of various events, such as the execution of an instruction, a miss in a cache or translation lookaside buffer, a buffer becoming full, instruction execution stalling, etc. The event count values maintained by the event counters can be read by debug software and used for analysis of software performance to help identify possible reasons for any performance issues when the software is executing on the data processing system.

### SUMMARY

At least some examples of the present technique provide performance monitoring circuitry for monitoring processing system performance; the performance monitoring circuitry comprising:
event count storage circuitry to store a plurality of event count values;
event monitoring hardware circuitry to maintain the event count values stored in the event count storage circuitry based on monitoring of events occurring in a processing system; and
derived event count calculating circuitry to perform an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

At least some examples of the present technique provide a system comprising:
the performance monitoring circuitry described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of performance monitoring circuitry for monitoring processing system performance; the performance monitoring circuitry comprising:
event count storage circuitry to store a plurality of event count values;
event monitoring hardware circuitry to maintain the event count values stored in the event count storage circuitry based on monitoring of events occurring in a processing system; and
derived event count calculating circuitry to perform an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

At least some examples of the present technique provide a method for monitoring processing system performance, the method comprising:
using event monitoring hardware circuitry, maintaining a plurality of event count values stored in event count storage circuitry based on monitoring of events occurring in a processing system; and
using derived event count calculating circuitry, performing an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a processing system having performance monitoring circuitry;

FIG. 2 illustrates an example of performance monitoring circuitry;

FIG. 3 illustrates a more detailed example of performance monitoring circuitry including derived event count calculating circuitry;

FIG. 4A illustrates an example of programmable control information for configuring the event count combination operation performed by the derived event count calculating circuitry;

FIG. 4B shows an algebraic representation of the event count combination operation;

FIG. 5 illustrates an example of generating derived event count values according to a dataflow computation model;

FIG. 6 illustrates an example of steps for monitoring processing system performance;

FIG. 7 illustrates an example of steps for performing an event count combination operation; and

FIG. 8 illustrates a system and a chip-containing product.

### DESCRIPTION OF EXAMPLES

Performance monitoring circuitry is provided for monitoring processing system performance. The performance monitoring circuitry comprises event count storage circuitry to store a plurality of event count values; and event monitoring hardware circuitry to maintain the event count values stored in the event count storage circuitry based on monitoring of events occurring in a processing system. The types of events monitored by the event monitoring hardware circuitry can be programmable, e.g. by setting event type information which selects the monitored event type to be tracked by a given event count value from among a set of event types supported by the performance monitoring circuitry. There can also be one or more event count values for which the type of monitored event is fixed by design. For example, a particular event count value may be reserved for counting the elapse of processing cycles.

Such performance monitoring circuitry can be useful to investigate possible causes of poor system performance, as the event count values can expose information about internal events occurring within the processing system while the software is executing (such as cache misses, branch mispredictions, instruction stalls, buffers becoming full, starvation of memory system bandwidth, etc.). The event count values can be readable by software executing on the processing circuitry.

In many performance monitoring architectures, each event count value maintained by the hardware tracks the number of occurrences of a single type of event-providing a simple count of the number of times that a particular event occurred. However, for many use cases, it may be desired to obtain more complex performance monitoring metrics which rely on combining two or more of the hardware-maintained count values to generate a derived count value. For example, a developer may wish to obtain a metric indicating a derived parameter such as the total number of events of any of two or more different types, the ratio of occurrences of one type of event to another type of event (or the fraction of total occurrences of both event types that relate to a single event), the difference between the number of occurrences of one event type and the number of occurrences of another event type, or the minimum or maximum number of occurrences of a given event type. Such derived metrics cannot be tracked by a single hardware counter alone. In most typical performance monitoring architectures, if such derived metrics are to be calculated, this would require the processor to read out the values of each of the relevant counters (each tracking a simple count of a number of occurrences of a given event type), and then software executing on the processor would specify instructions for controlling the processor to perform arithmetic operations on the read out count values, to calculate the derived metrics. However, this approach can be extremely invasive to the software whose performance is being analyzed using the performance monitoring circuitry, as at periodic intervals an interrupt may be generated to interrupt the software to allow the calculation of the derived metrics, and when the interrupt is generated there may be a delay of several hundreds of cycles while the count values are collected and processed, which can be harmful to performance of the software being analyzed and risk the derived metrics not giving a realistic view of the level of performance which would have been achieved if the software had run without interruption.

Some closed architectures, designed to satisfy the needs of closed systems provided by a single provider, may provide support for one or more hardware-maintained event count values which track derived metrics generated in a non-programmable (fixed and architecturally defined) operation performed on two or more other event count values. For example, a given event count value can be permanently reserved to track the fraction of memory accesses that are read memory accesses, for instance, with fixed non-programmable hardware generating that derived metric from counts of the number of read accesses and the number of write accesses. However, this approach is not suitable for an open architecture designed to be adaptable to many different systems with heterogeneous needs, as it is not feasible to design in the architecture options for selecting fixed non-programmable operations which would satisfy all of the many types of differing derived event count metrics which could be of use to software developers developing software for a wide variety of heterogeneous systems.

In the examples discussed below, the performance monitoring circuitry comprises derived event count calculating circuitry to perform an event count combination operation to update the event count storage circuitry to specify a derived event count value which depends on a combination of at least two event count values obtained from the event count storage circuitry. The event count combination operation performed by the derived event count metric calculating circuitry is programmable based on control information set in response to directives provided by a programming agent. For example, the performance monitoring architecture supported by the performance monitoring circuitry offers a number of control options allowing software to configure the way in which hardware-maintained event count values are combined to generate a derived event count value tracked in the event count storage circuitry. The derived event count value generated by the derived event count calculating circuitry can then be made available to software executing on the processor. In this way, the performance cost of generating derived event count metrics can be greatly reduced compared to an approach which relies on the processor calculating the metrics in software, but also the programmability of the event count combination operation enables a much wider variety of metrics to be available to users for profiling performance to address their specific problems in systems supporting an open architecture.

The control information for programming the derived event count metric calculating circuitry could be programmed in different ways. In some examples, the programming agent may be a processor of the processing system, so that the control information can be set in response to instructions executed by the processor. For example, a memory-mapped interface could be provided, so that the processor programs the control information by executing store instructions specifying memory addresses mapped to the control information. In some examples, the programming agent may be a debugger device (e.g. implemented as an external device separate from the processing system comprising the performance monitoring circuitry). For example, one or more debug pins may be provided at the boundary of the integrated circuit comprising the performance monitoring circuitry, to allow the debugger to issue control directives via the debug pins which cause the control information to be updated. Some examples may support both options (with both the processor and the external debugger being capable of acting as programming agents for setting the control information).

Various aspects of the event count combination operation may be programmable based on the control information set based on the directives provided by the programming agent. For example, selection of which of the at least two event count values are to be combined in the event count combination operation may be programmable based on the control information. In some examples, a type of combination function applied in the event count combination operation may be programmable based on the control information (e.g. the event count combination operation may select which arithmetic operation, logical operation or other combination operation is applied at a given step of the event count combination operation). In some examples, the event count combination operation may comprise two or more steps and the programmable control information may control selection of an operation to be applied at each of those two or more steps. The programmable control information could also define whether the event count combination operation is applied to two or more non-derived event count values (each generated by the event monitoring hardware circuitry based on counting of a single event type only), applied to two or more derived event count values (each previously having been generated based on a previous instance of performing an event count combination operation using the derived event count calculating circuitry), or is applied to a combination of one or more derived event count values and one or more non-derived event count values. Hence, the derived event count calculating circuitry can provide considerable flexibility to the user in selecting the particular way in which the hardware of the performance monitoring circuitry combines event count values to generate a derived event count value, rather than merely selecting from a fixed list of non-programmable derived event metrics which can be generated.

In some examples, the derived event count calculating circuitry is programmable to enable a processor to delegate the event count combination operation to be performed by the derived event count calculating circuitry. Hence, the derived event count calculating circuitry can be seen as taking the processing load away from the processor, by performing operations which would otherwise have to be performed by the processor. By delegating event count combination operation to the derived event count calculating circuitry, but nevertheless retaining programmable control (from the processor or another programming agent such as a debugger) to define the particular combination of steps performed for the event combination operation, the derived event counts can be generated with much less performance cost than if the processor itself calculated the derived event count values.

The delegation to the derived event count calculating circuitry may be such that the derived event count calculating circuitry is capable of performing the event count combination operation to update the event count storage circuitry to specify the derived event count value, even when all processors capable of instruction execution within the processing system are inactive. Hence, there is no need for the processor to retain active control of detailed steps of the event count combination operation (e.g. there is no need for the processor to execute step-by-step instructions relating to sub-steps within the event count combination operation). The processor or other programming agent can set the programmable control information in advance, and then the performance monitoring circuitry can run in the background of the processor carrying out other tasks (or even when the processor is currently in a power saving state not having any active processing to carry out), autonomously gathering event count values and combining them to generate derived event count metrics which the processor can then read out at a later time.

In some examples, for at least one setting of the control information, at least one of the at least two event count values on which the event count combination operation is performed is a previously derived event count value generated in a previous event count combination operation. Hence, the event count combination operation can be applied in a recursive manner so that a result of a first instance of the event count combination operation can then be further processed in a further event count combination operation (which may be programmed to have different parameters to the first instance of the event count combination operation, or could be the same operation as the first event count combination operation). For example, for generating a metric tracking a maximum or minimum value of a given quantity (e.g. buffer occupancy or memory system load) over a period of time, each instance of the event count combination operation could determine the maximum or minimum of the latest value of the corresponding non-derived event count value with the result of the previous maximum or minimum determined from a previous instance of the event count combination operation. More complex metrics such as determining average reuse distance between successive accesses to the same cache line may rely on two or more distinct event count combination operations being defined to update two or more different derived event count values, with a first event count value generated in the first of the event count combination operations providing an input to a second event count combination operation that generates a second event count value. Hence, by providing architectural support for a derived event count value to be an input to the event count combination operation, this enables collection of a much wider variety of metrics.

In some examples, the derived event count calculating circuitry is configured to perform the event count combination operation according to a dataflow computation model. Unlike a conventional von Neumann computation model, in which a program is defined by instructions defining a sequential series of operations, with a dataflow computation model the timing of triggering a given step of a dataflow program is determined based on whether a given trigger event has occurred, such as availability of input arguments for that step. This means various dataflow processing steps may be performed in an order which is not predefined, being dependent on the timings at which the various trigger events associated with those steps have occurred. For example, a given computation operation in the event count combination operation may be started under some user-defined triggering conditions (programmable based on the control information) to cause the computation operation to be performed on input values and write the result of the operation to one of the derived event count values. Use of a dataflow computation model for the derived event count allocated circuitry can be particularly powerful for recording more meaningful derived event count metrics, since it enables the metrics to be gathered specific to particular conditions arising in the processing system. For example, one use case could be to gather a derived metric based only on count values recorded at times of high system load (e.g. obtaining a measure of average response latency during times of high system load) which in some cases might give more meaningful insights than an average response latency calculated over all time which might be skewed by very fast response latencies at times of quiet load. The dataflow computation model can also avoid requiring detailed step-by-step instructions executed by the processor which would otherwise be needed with a von Neumann computation model, so this can make it simpler to reduce the processor load involved in calculating the derived event count value.

In some examples, for at least one setting of the control information, the derived event count calculating circuitry is configured to determine whether a trigger event condition is satisfied, and in response to determining whether the trigger event condition is satisfied, trigger the update of the event count storage circuitry to specify the derived event count value. The trigger event condition can be programmable based on the control information. This helps support the dataflow computation model of the derived event count calculating circuitry as described above.

For at least one setting of the control information, the trigger event condition is dependent on occurrence of an update to at least one of the event count values. A given event count value used to determine whether the trigger event condition is satisfied could be either a non-derived event count value or a derived event count value. By defining a trigger event condition such that the timing of updating a given derived event count value depends on whether at least one event count value has been updated, this can help support a wide variety of metrics such that the computation of a given derived metric can be defined by a “dataflow program” programmed based on the programmable control information.

In some examples, the trigger event condition could depend on only a single event count value being updated.

However, in some examples, the derived event count calculating circuitry may support at least one setting of the control information which specifies that the trigger event condition depends on two or more event count values. In this case, there can be different ways of determining whether the trigger event condition is satisfied, based on the two or more event count values. The derived event count calculating circuitry could support just one of these ways of determining whether the trigger event condition is satisfied, or could support more than one option, with the control information selecting which option is applied.

Hence, in some examples, for at least one setting of the control information, the trigger event condition is dependent on any one of a plurality of event count values being updated. For example, if the trigger event condition is defined relative to event count value A and event count value B, the trigger event condition may be considered satisfied if either event count value A or event count value B is updated (not necessarily requiring both to be updated).

In some examples, for at least one setting of the control information, the trigger event condition is dependent on a last event counter of a plurality of event count values being updated following previous updates being detected for each other of the plurality of event count values. For example, if the trigger event condition is defined relative to event count values A, B and C, then if only event count values A and C have been updated since tracking started, the trigger event condition would not yet be considered satisfied, but once event count value B is then also updated (event count value B in this example being the last of the plurality of event count values to be updated), then the trigger event condition may be considered satisfied. This setting can be useful in cases where the metric requires multiple independent conditions to be satisfied for the metric to be meaningful.

In some examples, for at least one setting of the control information, the trigger event condition is dependent on occurrence of at least one further non-event-count-dependent condition. For example, the further non-event-count-dependent condition could be elapse of a clock cycle, or the status of a given interface or bus meeting a particular requirement (e.g. meeting a “system load high” condition). In some examples, the trigger event condition could depend on either one of the following occurring: an update to one or more event count values (as in any of the examples discussed above), or the further non-event-count-dependent condition occurring (hence in this example if the further non-event-count-dependent condition occurs, the trigger event condition would be satisfied even if the event count value update condition has not been satisfied). In other examples, the trigger event condition could depend on both of the following occurring: an update to one or more event count values (as in any of the examples discussed above), and the further non-event-count-dependent condition occurring (hence this would mean neither the further non-event-count-dependent condition or the event count value update condition is enough in itself to trigger the update of the corresponding derived event count value—both conditions would need to be satisfied).

Hence, programmable control options may be supported to define a wide range of choices for trigger conditions (with programmability of the way in which multiple trigger requirements are combined, and of the particular trigger requirements selected), which can be useful for giving flexibility to calculate many derived event metrics locally within the performance monitoring circuitry which would otherwise require CPU involvement to calculate and/or would be virtually impossible to gather with CPU involvement (with CPU involvement, it would be difficult for certain metrics to be tracked specific to times of high memory system load, for example).

In some examples, for at least one setting of the control information, the derived event count calculating circuitry is configured to determine whether a result of the event count combination operation satisfies a threshold condition, and in response to determining that the result of the event count combination operation satisfies the threshold condition, trigger the update of the event count storage circuitry to specify the derived event count value. Hence, this can filter updates to the derived event count value depending on whether the result of the event count combination operation meets threshold condition. This can again be useful to cause the derived metrics to be more meaningful targeting specific scenarios, rather than being generic to all scenarios. The threshold condition can be based on comparison of the result of the event count combination operation with a threshold value. The programmable control information may define a threshold function for evaluating the comparison. The programmable control information may also define the threshold value. In some examples, the threshold condition can be considered satisfied if the result in the event count combination operation is greater than the threshold, or is less than the threshold, or is greater than or equal to the threshold, or is less than or equal to the threshold (depending on selected comparison function). It is also possible to define a threshold condition such that the threshold may be considered satisfied in cycles when the result of event count combination operation crosses the threshold in either direction (regardless of whether the result is rising above the threshold or dropping below the threshold). Hence, applying a threshold condition as a filtering step to determine whether to update the derived event count value can be helpful in increasing the variety of metrics that can be gathered by the performance monitoring circuitry.

Similarly, threshold conditions could also be applied at other steps of the event count combination operation, not just at the final stage of determining whether to update the derived event count value based on the final result of the event count combination operation. Hence, in some examples, the derived event count calculating circuitry may support at least one setting of the control information for which the derived event count calculating circuitry is configured to determine whether a result of an intermediate step of the event count combination operation satisfies a threshold condition, and in response to determining that the result of the intermediate step of the event count combination operation satisfies the threshold condition, perform at least one further step of the event count combination operation dependent on the result of the intermediate step to generate the derived event count value. The result of the event count combination operation can be independent of the result of the intermediate step, in cases when the result of the intermediate step does not satisfy the threshold condition. The threshold condition and/or the threshold value for the intermediate step's threshold function may be programmable, based on the control information.

The event count combination operation may comprise any operation that comprises one or more steps applied to two or more event count values, to generate a derived event count value. In some examples, the event count combination operation comprises an arithmetic operation, such as addition, subtraction, multiplication or division. It can be particularly useful for the derived event count calculating circuitry to support at least one setting of the control information for which the event count combination operation comprises addition or subtraction of the at least two event count values. This can help support combination functions for generating sums or differences of occurrences of two or more event types, or for tracking averages or other statistical functions (e.g. standard deviation) of parameters indicated by various event counters.

In some examples, for at least one setting of the control information, the event count combination operation comprises determining a maximum or minimum of the at least two event count values. This can be helpful to derive metrics indicating best case or worst case conditions seen over a period of time. It can be particularly useful to support maximum or minimum functions in cases where the maximum or minimum is determined based on a previously calculated derived event count value (generated in a previous instance of the event count combination operation) and a given non-derived event count value generated as a simple count of occurrences of a given event type by the event monitoring hardware circuitry, as this can help generate a metric indicating the maximum or minimum of the level indicated by the counter for that given event type across a number of time windows.

It will be appreciated that the derived event count calculating circuitry could be implemented in a wide variety of ways in hardware, with varying levels of complexity. There may be a trade-off between the desire to support more complex event count combination functions in hardware (supporting a wider variety of metrics) and the circuit area and power consumption costs incurred in providing increased complexity. Hence, some implementations may choose to implement a simpler circuit configuration with fewer programmable control operations for the event count combination operations.

In one particular example, the event count storage circuitry is configured to store a plurality of non-derived event count values maintained by the event monitoring hardware circuitry and one or more derived event count value generated by the derived event count calculating circuitry, and the derived event count calculating circuitry comprises: non-derived event count summation circuitry to perform addition or subtraction of at least a subset of the non-derived event count values to generate a non-derived event count dependent output; and combining circuitry to combine the non-derived event count dependent output with a derived event count dependent output dependent on at least a subset of the one or more derived event count values, to generate a result derived event count value corresponding to a result of the event count combination operation. This approach can provide a relatively simple circuit implementation but nevertheless offers considerable flexibility to generate a variety of derived event count metrics which would otherwise be less feasible with traditional performance monitoring approaches.

For example, the combination of the non-derived event count dependent output and the derived event count dependent output could calculate a sum or difference of the non-derived event count dependent output and the derived event count dependent output, or could calculate a minimum or maximum of the non-derived event count dependent output and the derived event count dependent output (some implementations may support multiple options with programmable selection of which combination function is applied to the non-derived event count dependent output and the derived event count dependent output).

In some cases, the derived event count dependent output could itself depend on an addition or subtraction of two or more derived event count values calculated by derived event count summation circuitry (those two or more derived event count values each depending on a derived event count value determined in a previous instance of performing the event count combination operation).

The approach discussed above can be used for a wide variety of performance monitoring circuit use cases, at different points of a processing system. In some examples the performance monitoring circuitry may be provided local to the processor to track event count values indicative of events occurring within the processor in response to execution of software (e.g. the event types supported for being counted may include parameters such as instruction fetch events, branch mispredictions, translation lookaside buffer misses, pipeline flushes, instances of instructions of a given type being executed, etc.).

However, the use of programmable event count combination operations implemented in hardware by the derived event count calculating circuitry can be particularly helpful for system performance monitoring circuitry which is implemented deeper within the memory system of a processor system, to track event count values relating to memory system utilisation, which are not necessarily specific to a particular CPU (central processing unit) but could also depend on non-CPU events caused by an agent other than a CPU (e.g. memory accesses or state transitions of peripherals, levels of traffic in a network on chip, etc.). Hence, in some examples, for at least one control setting of the performance monitoring circuitry, the event monitoring hardware circuitry may monitor non-CPU events caused by an agent other than a central processing unit (CPU), and update at least one of the event count values depending on monitoring of the non-CPU events (as well as monitoring CPU events, in some examples). For system performance monitoring circuits located more remote from the CPU, the performance costs of calculating derived event count metrics in a traditional manner using software executing on the CPU can be particularly high because of the increased latency in the CPU reading out event count values from the system performance monitoring circuitry, so the provision of programmable derived event count calculating circuitry as discussed above can be particularly helpful to reduce the performance cost of gathering derived event count metrics using a system performance monitoring unit that is not tied to a particular CPU.

Specific examples are now described with reference to the drawings.

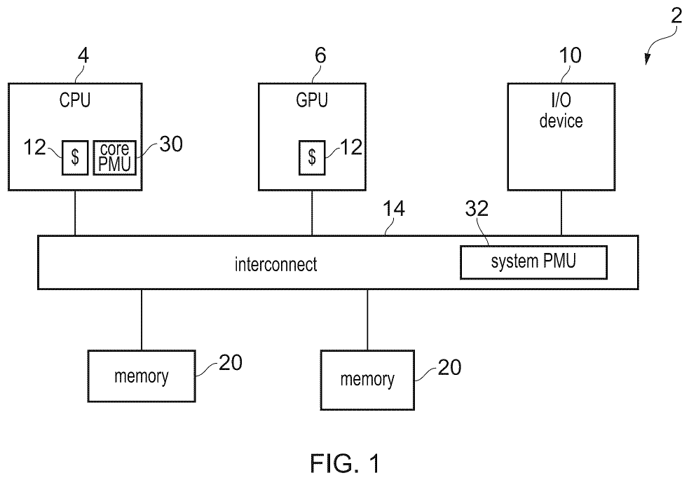

FIG. 1 illustrates an example of a processing system 2 comprising one or more memory access initiators. In this example the memory access initiators include a processor (CPU-central processing unit) 4 and non-CPU memory access initiators, for this example, a graphics processing unit (GPU) 6 and input/output (I/O) device 10. While FIG. 1 for sake of example shows one initiator of each type (CPU 4, GPU 6 and I/O device 10), it will be appreciated that the system 2 could include more than one initiator of a given type, could include additional types of memory access initiators not shown in FIG. 1 (e.g. a hardware accelerator) and may not necessarily include all of the types of memory access initiators 4, 6, 10 shown in FIG. 1. The memory access initiators 4, 6, 10 communicate with each other and with memory storage 20 via a system interconnect 14. Some of the access initiators 4, 6 may have caches 12 for caching data or instructions obtained from memory 20. It will be appreciated that FIG. 1 is merely a simplified representation of some components of a possible processing system, and the system could include other elements not illustrated for conciseness.

The system 2 has at least one instance of performance monitoring circuitry. In this example, the processor includes performance monitoring circuitry, referred to as the “core performance monitoring unit” (“core PMU”) 30, which is located at the CPU 4 for monitoring internal events within the CPU 4 that are specific to instruction execution and memory access by the CPU 4. Also, a further instance of performance monitoring circuitry, referred to as “system PMU” 32, is located within the memory system (in this example associated with the interconnect 14, but the system PMU 32 could also be implemented at other parts of the memory system). The system PMU 32 monitors events associated with memory system access which may be associated with accesses to memory made by any of the memory access initiators 4, 6, 10, including the non-CPU memory access initiators 6, 10. The system PMU 32 may, for example, track metrics associated with system cache accesses (accesses to a system cache shared between the memory access initiators 4, 6, 10), memory bus bandwidth utilisation, coherency operations managed by the interconnect 14, etc. While FIG. 1 shows an example comprising both the core PMU 30 and system PMU 32, other examples could only include one of these types of performance monitoring circuitry or could include performance monitoring circuitry at other system locations.

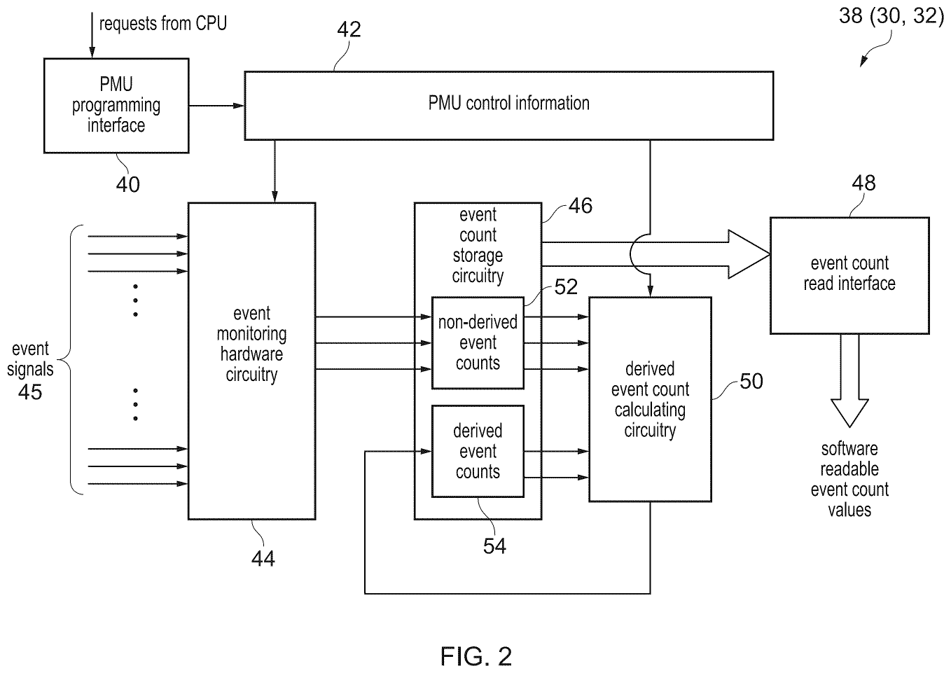

FIG. 2 illustrates an example of the performance monitoring circuitry 38, which could be used for either the core PMU 30 or the system PMU 32. As shown in FIG. 2, the performance monitoring circuitry 38 includes a number of event counters 52, 54 provided by event count storage circuitry 46. Each event counter 52, 54 comprises a register which, in use, stores a corresponding event count value which is maintained automatically in hardware by event monitoring hardware circuitry 44 or derived event count calculating circuitry 50. The operation of the event monitoring hardware circuitry 44 and the derived event count calculating circuitry 50 is programmable, based on performance monitoring unit (PMU) control information 42 set in response to directives issued by a programming agent (e.g. by software executing on the processor (CPU) 4, or by a debugger via debug interface pins of the integrated circuit comprising the performance monitoring circuitry 38). The control information 42 defines how the event count values are to be generated by the event monitoring hardware circuitry 44 and derived event count calculating circuitry 50. For example, the PMU control information 42 could include information stored in registers 14 of the CPU 4 (e.g. system registers), information stored in memory-mapped registers implemented as distinct hardware separate from the general random access memory storage 20, and/or information stored within the memory storage 20 itself. In the case of memory-mapped registers or a data structure in memory 20 being used to provide the counter configuration information, the event monitoring hardware circuitry 44 and the derived event count calculating circuitry 50 may access those registers/structure based on a base address that is programmable by the user.

A programming interface 40 is provided to allow a user (e.g. a software developer performing debugging) to set the PMU control information 42. The control information 42 could be set in response to instructions executed on the CPU 4 (e.g. system register updating instructions, or store instructions specifying a store target address which is mapped to the memory-mapped registers used to provide the PMU control information 42, or to a PMU control data structure stored in memory 20). Hence, the software developer has flexibility to configure the event counters 52, 54 to gather various types of performance monitoring information of interest when debugging a particular program running on the CPU 4 or GPU 6 or assessing memory system performance issues. For example, debugging software may be executed to set the PMU control information 42. Alternatively, debug hardware accessing the PMU control information 42 via a debug interface port may issue control signals for setting the PMU control information 42. Either way, a target program being debugged can then be executed. During execution of the target program, the performance monitoring circuitry 38 operates in the background of continued program execution on the CPU 4 or GPU 6, with the performance monitoring carried out under hardware control according to the previously set counter configuration information, without requiring step-by-step instructions to be executed by the CPU 4 to direct each counter update to be performed.

A subset of the event counters are non-derived event counters 52, maintained in hardware by the event monitoring hardware circuitry 44 based on monitoring of occurrences of an event of a given type. The event counters also include derived event counters 54 maintained by the derived event count calculating circuitry 50 based on combining values from two or more of the non-derived or derived event count values 52, 54. The derived event counters 54 will be described in more detail below.

The event monitoring hardware circuitry 44 receives from various parts of the data processing system 2 a number of event signals 45 each indicating status of a corresponding type of event. Although shown as a single logic block in FIG. 2, the event monitoring hardware circuitry 44 may comprise a separate event selector for each non-derived event counter 52, which independently selects the event signal 45 to be monitored by the corresponding non-derived event counter 52, from among a set of supported event types.

For example, event signals could be generated to indicate a wide variety of types of information about various components of the data processing system 2.

Some event signals may indicate the occurrence of a specific action (or a count of how many times that action has occurred). For example, such an action may include any of:
elapse of a clock cycle;
execution of an instruction (either any instruction in general, or an instruction of a specific type);
a memory access request being made (either any memory access in general, or memory accesses of specific types, e.g. loads or stores);
a cache access, cache linefill or cache miss occurring (in some cases, this could be specific to a particular level or type of cache);
a TLB access, TLB linefill or TLB miss occurring (again, this could be events tracked for any TLB in general, or could be specific to particular TLB instances (e.g. data-side TLB or instruction-side TLB) or particular TLB levels (e.g. level 1 or level 2));
a branch misprediction occurring;
a queue or buffer becoming full (variants of which can be provided for specific buffers such as an instruction issue queue, load buffer, store buffer, etc.);
a stall of the pipeline occurring due to a particular cause (e.g. a cache miss, a TLB miss, or a load or store buffer becoming full).
a stall of memory system processing due to a structure within the memory system becoming full or insufficient bandwidth being available on a memory system bus; or a snoop request or snoop response being issued or received.

Other event signals may specify quantitative information providing a quantitative status value indicating a property of an event that has occurred, such as:
a number of page table walk operations (requests to fill the TLB with a page table entry loaded from memory) in progress in a given cycle;
a number of cache linefill requests (requests to bring data into a cache following a cache miss) pending in a given cycle; or
an indication of current occupancy of a particular instance of a queue or buffer provided in hardware.

It will be appreciated that the lists of event types above are not exhaustive and that a wide variety of different event types could be monitored.

Also, in some cases, the event type assigned to a given event counter 52 may be the overflow of another of the event counters 52, which allows the numeric range over which a particular event is counted to be expanded beyond the numeric range supported in a single counter. Note that in this case although the two counters are “chained” together in the sense that they effectively represent a larger counter counting a single event type, the resulting count value tracked by the second event type in the chain (the one being incremented based on the overflow of the first event counter) is not a function of a combination of two distinct event types being monitored by respective event counters 52, 54, as the second chained counter is incremented based on occurrences of the first counter's overflow only, not a logical combination of two or more distinct counters.

The PMU control information 42 includes event type assignment information which specifies the event type to be monitored by each non-derived event counter 52. For example, each non-derived event counter 52 may be associated with a corresponding event type field within the PMU control information 42, the event type field having an encoding selecting which of the event signals 45 should trigger updates of a particular event counter 52. For each event counter, the event monitoring hardware circuitry 44 selects, based on the event type assignment information for that counter, one of the event signals 45. Each event counter 52 has a set of hardware circuit logic including storage circuitry (e.g. a register) for storing the corresponding event count value and counter control logic circuitry (implemented in hardware) for updating the event count value as a function of the event signal 45 provided to that counter 52 by the event monitoring hardware circuitry 44. For example, an increment value may be selected as a function of the event signal 45, and a new value of the event count value tracked by the counter 52 may be calculated by adding the increment value to the previous value of that event count value. Control signals generated based on the PMU control information 42 may configure how a given counter selects the function to be applied to the event signal 45 and how the increment value is to be selected based on the result of applying the function to the event signal 45.

The performance monitoring circuitry 38 provides an event count read interface 48 which allows software to read the event count values of each event counter 52, 54 from the event count storage circuitry 46. For example, the read interface 48 may be provided by exposing each event counter 52, 54 to software as system registers which can be read by system register read instructions executed by the CPU 4. Alternatively, the event count values of each event counter 52, 54 may be exposed through a memory-mapped interface so that they can be read by the software on the CPU 4 executing load instructions specifying memory addresses mapped to the storage locations storing the respective event count values. In some examples, the event count read interface 48 may also allow event count values to be output via a debug interface port to an external debugger. Hence, debugging software executing on the CPU 4 or on an external device can read the current values of each event count value to determine information about what has happened when target software was being processed by the processing system 2. In use, for example, breakpoints or watchpoints may be established to cause an exception to be generated when the target software has reached the desired point at which investigation is required (e.g. a desired instruction address reached in program flow, or a desired data address accessed by a memory access instruction), and then when the exception is triggered, an exception handler provided by the debugging software, or the external debugger issuing control directives via the debug interface port, can read out the event count values from certain event counters 52, 54 and analyze the information provided by those event count values to determine what has happened. This can be useful for diagnosing potential performance inefficiencies in the program code, to help identify possible improvements that could be made to the program code being executed to allow it to run more efficiently.

The performance monitoring circuitry 38 includes derived event count calculating circuitry 50 which is programmable, based on the PMU control information 42, to perform an event count combination operation on two or more event count values obtained from the event count storage 46 to generate a derived event count value which is written to one of the derived event counters 54 maintained in the event count storage 46. The event count values used as inputs to the event count combination operation could include non-derived event count values 52 only, derived event count values 54 only, or one or more non-derived event count values 52 in combination with one or more derived event count values 54. The event count combination operation may include at least one arithmetic/logical operation step, such as addition, subtraction, multiplication, division, minimum or maximum operation performed on two or more of the event count values 52, 54, to allow for calculation of more complicated metrics using programmable hardware within the PMU 40, improving performance compared to an approach in which the same metrics are calculated in software by the CPU 4 following read out of the non-derived event count values 52 via the event count read interface 48.

The derived event count calculating circuitry 50 may support one, two or more derived event counters 54 each for recording the outcome of a respective type of event count combination. For each derived event counter 54, the corresponding event count combination operation is programmable based on the PMU control information 42, e.g. to select which particular event counters 52, 54 are used as inputs for the event count combination operation, select the particular type of arithmetic/logical operations applied at certain steps of the event count combination operation, select a threshold function applied at an intermediate step or final step of the event count combination operation to determine whether an output of that step is to be considered valid, and/or define trigger events which govern when a particular event count combination operation is active to update the corresponding derived event counter 54.

This enables delegation (offloading) of arithmetic/logical operations to the performance monitoring circuitry 38, with the performance monitoring circuitry 38 acting as a basic “dataflow” computation engine to generate derived event count values as functions of various performance events. The term dataflow refers to a computation which is started under some user-defined triggering conditions on occurring events, and which stores outcomes into a destination register. The update of the destination register with each of these outcomes is itself an event, which can trigger further computation.

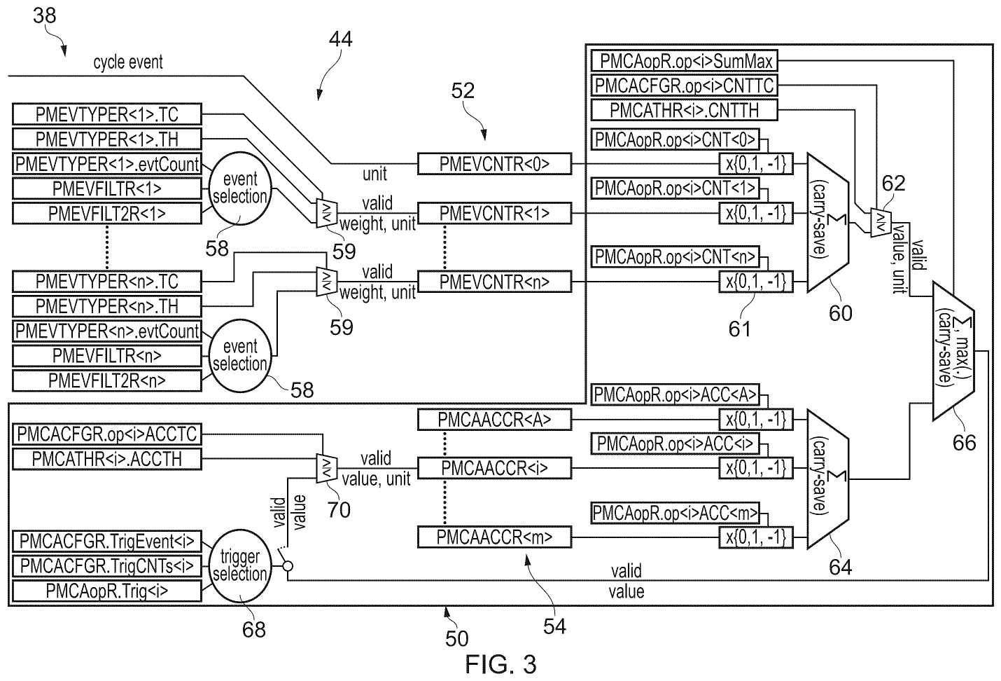

FIG. 3 illustrates a portion of the performance monitoring circuitry 38 in more detail. The performance monitoring circuitry includes registers PMEVCNTR<0> to PMEVCNTR<n> providing a given number of non-derived event counters 52. The number of non-derived event counters 52 actually provided could vary depending on the particular implementation. In this example, non-derived event counter PMEVCNTR<0> is a non-programmable event counter which, by default, counts a number of elapsed clock cycles. There is no option to reprogram which type of event is counted by PMEVCNTR<0>.

The other non-derived event counters 52, PMEVCNTR<1> to PMEVCNTR<n>, are programmable to adjust which type of event is counted and adjust filter and/or threshold conditions applied to determine whether a given occurrence of the event triggers a count value update. For each of the programmable event counters PMEVCNTR<1> to PMEVCNTR<n> the event monitoring hardware circuitry 44 comprises event selection circuitry 58 and thresholding circuitry 59. The event selection circuitry 58 for a given non-derived event counter PMEVCNTR<i> selects the type of event counted by that event counter PMEVCNTR<i> depending on an event type parameter evtCount. The evtCount parameter (in this example stored in an event type register PMEVTYPER<i> corresponding to counter PMEVCNTR<i>) is used to select which event signal 45 is selection for determining updates to the count value of that counter. The event selection circuitry 58 may also select whether to apply an update to the corresponding counter PMEVCNTR<i> depending on whether one or more filter conditions are satisfied. In this example, the filter conditions are defined by filter control parameters in one or more filter registers PMEVFILTR<i>, PMEVFILT2R<i>. For example, the filter conditions could specify that the counter is to be updated only for memory transactions specifying a particular identifier or class of identifiers, or is only to be updated when the processing circuitry is in a particular mode, or is only to be updated when the event relates to a memory address within a certain range, etc.

Hence, if the signal level on the event signal of the type selected based on evtCount meets any filter conditions defined by the filter control parameters, the event signal is forwarded to the thresholding circuitry 59, which determines whether the event signal is valid, based on a threshold test being applied (if enabled). If the threshold test is disabled, the event signal is considered valid regardless of any comparison with a threshold value. If the threshold test has been enabled, the thresholding circuitry 59 determines whether the event signal meets a threshold condition determined with reference to a threshold value TH defined for counter PMEVCNTR<i>. A threshold control parameter TC associated with counter PMEVCNTR<i> controls the thresholding circuitry 59 to adjust (i) whether a threshold test is enabled or disabled, and (ii) if the threshold test is enabled, the particular threshold condition required to be satisfied. For example, the threshold control parameter TC could select whether to compare the event signal with the threshold value TH according to a greater than, less than, greater than or equals, or less than or equals comparison function. In some cases, the threshold control parameter TC could also select whether the threshold test is evaluated based on a level thresholding function, for which the threshold condition is considered satisfied if the level of the event signal meets the selected comparison condition and continues to be satisfied in each subsequent cycle where the selected comparison condition still holds true, or an edge thresholding function, for which the threshold condition is satisfied in a cycle when the event signal crosses the threshold value TH (either checking specifically for leading edges when the event signal rises above the threshold, or checking specifically for falling edges when the event signal drops below the threshold, or being satisfied for either leading or falling edges), but for the edge thresholding function the threshold condition would not be satisfied in subsequent cycles unless a further edge crossing event is detected when the signal transitions from one side of the threshold to the other side. If the threshold test is disabled, or if the threshold test is enabled and the defined threshold condition is satisfied, then a valid counter update event is signalled and the corresponding event counter PMEVCNTR<i> is incremented by a given increment amount (e.g. +1, by the value of the corresponding event signal, or by another increment amount). In examples a “weight” control value may define the size of the increment to be applied in the case the threshold function is satisfied, either as an absolute increment value or as a weight to be applied as a multiple of the event signal value itself. If the threshold test is enabled but the threshold test is not satisfied in a given cycle, the event counter PMEVCNTR<i> is not updated in the given cycle.

While FIG. 3 shows an example in which each of the non-derived event counters PMEVCNTR<1> to PMEVCNTR<n> (other than the fixed cycle counter PMEVCNTR<0>) is associated with control parameters enabling configuration of filter conditions and a threshold condition, this is not essential, and in some examples only a subset of the counters 52 could be provided with the filtering and/or thresholding logic (in this case, when programming the control information for the performance monitoring circuitry 38, the user can adjust their choice of which events to assign to each counter 52 to ensure that the event types for which the filtering and/or thresholding logic is useful are assigned to counters 52 that support those functions).

In a similar way to the non-derived event counters 52, registers PMCAACCR<A>, . . . PMCAACCR<i>, . . . PMCAACR<m> are provided for storing derived event counters 54, In this example, three derived event counters 54 are shown, each associated with a respective event count combination operation which is programmable based on the control information 42 set by the user. However, it will be appreciated that some examples might support only one or two derived event counters 54, or could support more than three derived event counters 54. Also, in FIG. 3, for conciseness the circuitry for performing the event count combination operation is shown only for the first derived event counter PMCAACCR<A>, but it will be appreciated that similar circuitry can be provided for other derived event counters 54 (if supported).

In this example, the derived event count calculating circuitry 50 comprises non-derived event count summation circuitry 60, which performs a weighted sum of a subset of non-derived event count values tracked by the non-derived event counters 52, to generate a non-derived event count dependent output value. Each of the count values 52 input to the sum can be weighted by a corresponding weight parameter (defined by the programmable control information 38), which in this example is provides a weight of either 0, +1 or −1. Hence, by selecting the weight, this can adjust whether the corresponding count value is added (corresponding to +1 weight), subtracted (corresponding to −1 weight) or whether that count value is eliminated from contributing to the sum result at all (corresponding to 0 weight). In other examples, other weight values could be supported (e.g. a weight of +2 or −2). Hence, the non-derived event count dependent output value is determined according to a sum of terms (weight*count value), summed across each of the count values input to the non-derived event count summation circuitry 60. While FIG. 3 shows an example where each of the non-derived event counters PMEVCNTR<0> to PMEVCNTR<n> is provided as an input to the non-derived event count summation operation, other examples might restrict the choice of non-derived event counters available for combining in the event count combination operation, so that only a smaller subset of event counters 52 can contribute to the event count combination operation, and other event counters 52 cannot act as inputs to the event count combination operation. This can help limit the circuit complexity for the derived event count calculating circuitry 50 and limit the amount of programmable control information 38 required to configure the derived event count completing circuitry 50. Again, any limitation in the choice of which counters 52 are available for inputs to the combination operation can be taken into consideration by the user when deciding which counters 52 to assign to count particular event types, so that the user programming the performance monitoring circuitry 38 can ensure that the types of events which need to be combined in the event count combination operation are assigned to those non-derived event counters 52 which support their event count values being input to the non-derived event count summation operation.

The derived event count calculating circuitry 50 also includes derived event count summation circuitry 64, which performs a weighted sum of at least a subset of derived event count values tracked by the derived event counters 54, to generate a derived event count dependent output value. Again, each derived event count value can be weighted by multiplying it with a corresponding weight value (e.g. selected from the set 0, +1, −1 as above), before the weighted count values are added by the derived event count summation circuitry 64.

In this example, the non-derived dependent output value generated by summation circuitry 60 is passed to thresholding circuitry 62 to apply a similar threshold function to the threshold function applied by thresholding circuitry 59. However, the threshold function applied to the non-derived dependent output value is configured based on a separate set of control parameters (CNTTC, CNTTH) compared to those parameters (TC, TH) which control thresholding for individual non-derived event counters 52. Hence, the threshold functions described above for thresholding circuitry 59 can also be applied by thresholding circuitry 62 to the non-derived dependent output value generated by non-derived event count summation circuitry 60. If the threshold condition applied by the thresholding circuitry 62 is both enabled and satisfied, or the threshold test is disabled altogether, then the output of the non-derived event count summation circuitry 60 is indicated as valid and is passed to combining circuitry 66 for a subsequent step of the event count combination operation. If the threshold condition is enabled but the threshold condition is not satisfied, the output of the non-derived event count summation circuitry 60 is indicated as invalid and does not influence the subsequent processing step performed by combining circuitry 66.

In this example, there is no similar thresholding circuitry between the derived event count summation circuitry 64 and the combining circuitry 66, although a similar threshold function to that applied by threshold circuitry 59 or 62 could be implemented for the output of derived event count summation circuitry 64 in other examples.

Combining circuitry 66 combines the non-derived event count dependent output (if valid) with the derived event count dependent output, to generate a result derived event count value corresponding to a result of the event count combination operation. In this example, the combining circuitry 66 supports two alternative options for combining the non-derived/derived event count dependent outputs:
a summation operation, to add the non-derived event count dependent output (if valid) and the derived event count dependent output. If the non-derived event count dependent output is invalid then the summation result is equal to the derived event count dependent output; and
a maximum operation, to determine the maximum of the non-derived event count dependent output (if valid) and the derived event count dependent output. If the non-derived event count dependent output is invalid then the maximum result is equal to the derived event count dependent output.
   In other examples, other options could also be supported for the combination operation applied by combining circuitry 66. A programmable control parameter “SumMax” selects which combination operation is applied by combining circuitry 66.

In this example, the addition circuitry used for each summation 62, 64, 66 is implemented using addition circuitry which generates the corresponding summation result in a redundant (e.g. carry-save) representation comprising two or more redundant terms which together represent the value of the corresponding summation result. Use of a redundant representation makes it simpler to meet circuit timing constraints than if carry-propagate addition was used, as the delay of carry chains is eliminated. Conversion of the redundant representation to a non-redundant representation could be performed either at the end of the overall event count combination operation (just before the derived event count value is written to a given derived event counter 54) or, if the derived event counts are stored in the event count registers 54 in redundant representation, conversion to non-redundant representation could be deferred to the point at which the stored derived event count value is to be read out using the event count read interface 48.

To support the dataflow computation model of the derived event count calculating circuitry 50, trigger condition circuitry 68 is provided to determine whether a programmable trigger condition is satisfied. The trigger condition can be dependent on occurrence of various events (e.g. whether one or more event counters 52, 54 have encountered an update, and/or on whether other non-event count related conditions are satisfied). Control parameters TrigCNTs<i>, TrigEvent<i>, Trig<i> can be used to control the selection of which events are used to detect the trigger condition and the particular way in which those events are combined if multiple trigger events have been defined. This can be helpful to define a “dataflow program” whereby a firing rule arising for one or more event counters causes further event count combination operations to be triggered, which may themselves then cause other event count combination operations to be triggered, allowing for calculation of relatively complex derived event count metrics using the relatively simple hardware at the performance monitoring circuitry 38, under control of the programmable control information set by software executing on the CPU 4 to delegate those computations to the performance monitoring circuitry 38.

Also, derived event count thresholding circuitry 70 is provided to apply a further threshold test to the result of the event count combination operation generated by combining circuitry 66, in a similar way to the threshold conditions applied by circuitry 59, 62 described earlier. Again, the threshold functions may be controlled based on a threshold value defined by a threshold value defining control parameter ACCTH and a threshold control parameter ACCTC which configures the type of threshold condition applied, in a similar way to the thresholding described above for circuitry 59 based on the corresponding parameters TH and TC. In some examples, the derived event count thresholding circuitry 70 may be supported only for a subset of the derived event counters (e.g. only for PMCAACCR<A> but not for other derived event counters PMCAACCR<i>, PMCAACCR<m>), so not all of the derived event counters 54 may be associated with thresholding circuitry 70. For a derived event counter not having the thresholding circuitry 70, validity of the result does not depend on any threshold condition. For a derived event counter having associated thresholding circuitry 70, when a threshold condition is enabled, the validity of the result of the event count combination operation depends on whether the trigger condition evaluated by trigger condition circuitry 68 is satisfied. If the result of the event count combination operation is indicated as valid, the corresponding derived event counter 54 is updated to specify the result. If the result of the event count combination operation is indicated as invalid in a given cycle (either because the threshold condition is enabled but not satisfied, or because the associated trigger event checked by trigger condition circuitry 68 is not satisfied), the corresponding derived event counter 54 is not updated in that cycle.

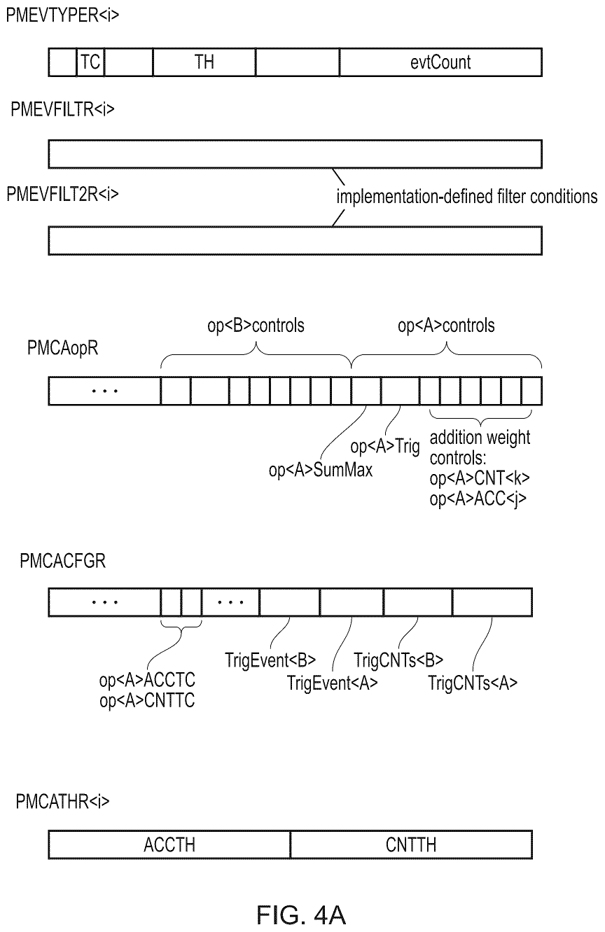

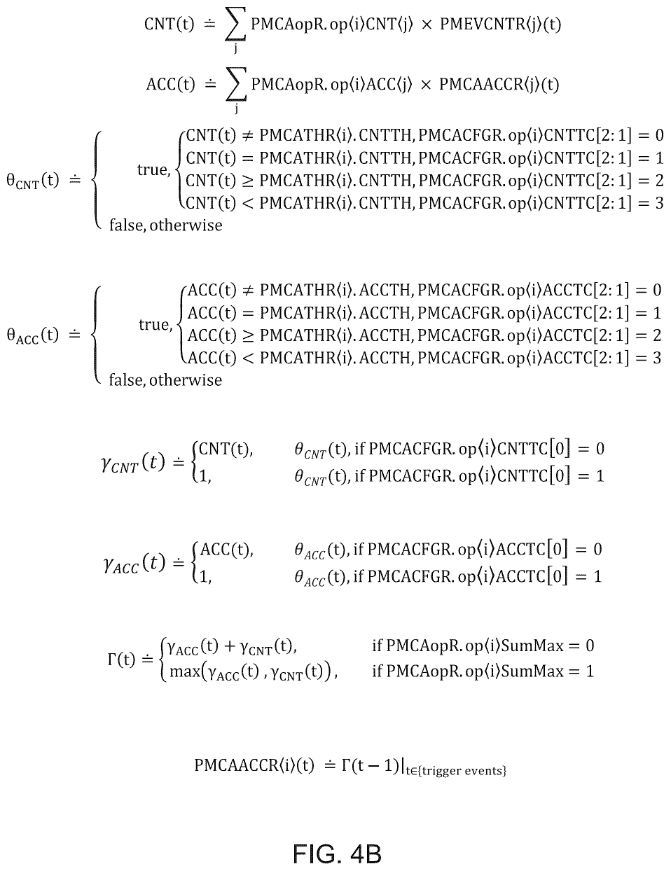

FIG. 4A illustrates an example of a portion of the control information 42 for programming the performance monitoring circuitry 38, including control information for programming the derived event count calculating circuitry 50 to perform the event count combination operation. It will be appreciated that all register and field names are exemplary and the same information could be provided in registers and fields with different names. Also, it will be appreciated that the particular division of information between registers could be varied, and other examples could split contents of one of the registers shown in FIG. 4A into multiple registers or combine information from multiple registers into a single register. Each register shown in FIG. 4A could be a system register or a memory mapped register which is mapped into the address space accessible to software executing on the CPU 4. Other examples may provide the equivalent control information in a memory-based data structure stored within the memory storage 20.

For this example, the PMU control information 42 includes registers with fields as follows:

PMEVTYPER<i> (event type register for controlling non-derived event counter <i>):
evtCount: selects the event type counted by non-derived event counter <i>.
TH: threshold value for evaluating the threshold function described above for thresholding circuitry 59;
TC: configures the threshold function applied by thresholding circuitry 59, e.g. encoded as a 3-bit value as follows:
   TC[0]: selects type of threshold function applied.
      b0 (binary 0): “count value passing threshold” (level dependent threshold test): the threshold function is satisfied if count value meets a comparison condition evaluated based on a comparison of the count value and the threshold value TH;
      b1 (binary 1): “count value crossing threshold” (edge dependent threshold test): the threshold function is satisfied in a cycle when the count value crosses the threshold value defined by TH in either direction, and is not satisfied in a cycle when the count value remains the same side of the threshold TH as in the previous cycle;
   TC[2:1]: configures the comparison condition to be applied in cases when TC[0]=0.
      b00: Not-equal;
      b01: Equals;
      b10: Greater-than-or-equal;
      b11: Less-than.
         PMEVFILTR<i>, PMEVFILT2R<i>: filter registers for defining filter conditions, which control whether, in a given cycle, non-derived event counter <i> is updated based on the event signal corresponding to the event type selected based on PMEVTYPER<i>.evtCount. The format of the filter registers may be implementation-specific (not architecturally defined), so a designer of a particular system implementation may choose certain types of filter controls to be implemented (an implementation-specific software driver executing on the CPU 4 may be aware of the particular controls offered by a given processing system and program the relevant filter controls accordingly). Examples of filter controls that could be offered could include:
filtering by transaction ID, to ensure that the corresponding non-derived event counter <i> is updated only in response to events of type evtCount that occur for memory system transactions having the specified transaction ID.
filtering by read/write, to cause the corresponding non-derived event counter <i> to be updated in response to events of type evtCount occurring for read transactions only, write transactions only or both read/write transactions.
   The particular filter conditions supported for filtering non-derived event count updates could vary significantly from one system to another.
   PMCAopR, counter arithmetic operation register, which defines the arithmetic operation for generating the derived event count value to be written to the derived event counters 54 (the derived event counters 54 themselves being represented by registers PMCAACCR<i> where i is A to m in the example of FIG. 3). In the example of FIG. 4A, for conciseness only two derived event counters <A> and <B> are supported, with independent controls for op<A> and op<B> configuring the respective event count combination operations for each derived event counter <A> and <B> (for conciseness these controls are described below with respect to op<i>, but separate instances of these controls are provided for i=A and i=B in FIG. 4A). It will be appreciated that other examples could extend to more than two derived event counters 54.
   In one example, PMCAopR is encoded as follows (the op<B> controls not being shown explicitly in FIG. 4A, but following a corresponding format to the op<A> controls):

### PMCAopR

$$reserved [ 63 : 32 ] = RAZ ( read as zero )$$

$$op < B > Sum Max [ 31 ]$$

$$reserved [ 30 ] = RAZ$$

$$op < B > Trig [ 29 : 28 ]$$

$$op < B > ACC < B > [ 27 : 26 ]$$

$$op < B > ACC < A > [ 25 : 24 ]$$

$$op < B > CNT < 3 > [ 23 : 22 ]$$

$$op < B > CNT < 2 > [ 21 : 20 ]$$

$$op < B > CNT < 1 > [ 19 : 18 ]$$

$$op < B > CNT < 0 > [ 17 : 16 ]$$

$$op < A > Sum Max [ 15 ]$$

$$reserved [ 14 ] = RAZ$$

$$op < A > Trig [ 13 : 12 ]$$

$$op < A > ACC < B > [ 11 : 10 ]$$

$$op < A > ACC < A > [ 9 : 8 ]$$

$$op < A > CNT < 3 > [ 7 : 6 ]$$

$$op < A > CNT < 2 > [ 5 : 4 ]$$

$$op < A > CNT < 1 > [ 3 : 2 ]$$

$$op < A > CNT < 0 > [ 1 : 0 ] .$$

Where these fields are interpreted as follows:
op<i>SumMax (i=A or B): select sum or maximum computation applied by combining circuitry 66 for operation <i> used to generate derived event counter PMCAACCR<i>:
   b0: sum computation
   b1: max computation
op<i>Trig: (i=A or B) source of trigger for computation of operation “i” in addition to PMCACFGR.TrigCNT<i>. PMCAACCR<i> is updated soon after any PMEVCNTR<j>, with PMCACFGR.TrigCNT<i>[j]=b1, has been updated, if threshold control is fulfilled. PMCACFGR.TrigCNT<i> can be 0, disabling all updates if any PMEVCNTR has changed. Trig<i> takes the following encodings:
   b00: PMCAACCR<i> is updated when any of the counters selected by PMCACFGR.TrigCNT<i> is updated.
   b01: PMCAACCR<i> is updated when the event selected by PMCACFGR.TrigEvent<i> fires or any of the counters selected by PMCACFGR.TrigCNT<i> is updated.
   b10: PMCAACCR<i> is updated when the last of all the counters selected by PMCACFGR.TrigCNT<i> is updated.
   b11: PMCAACCR<i> is updated when the first event selected by PMCACFGR.TrigEvent<i> fires after all the counters selected by PMCACFGR.TrigCNT<i> have been updated.
op<i>CNT<k>: (i=A or B, k=0 . . . 3)-select factor when summing non-derived counter “k” (i.e. PMEVCNTR<k>) for event count combination operation “i”
   b00: multiply by 0.
   b01: multiply by 1.
   b10: multiply by −1.
   b11: reserved.
op<i>ACC<j>: (i=A or B, j=A or B) select factor when summing derived event counter “j” (i.e. PMCAACCR<j>) for operation “i”:
   b00: multiply by 0.
   b01: multiply by 1.
   b10: multiply by −1.
   b11: reserved.
      PMCACFGR: counter arithmetic configuration register. Defines information for configuring the threshold function applied by thresholding circuitry 62, 70 and the trigger conditions applied by trigger condition circuitry 68. In this example, the threshold function is supported only for event count combination operation <A> used to generate PMCAACCR<A>, and is not supported for operation <B>, but other examples could define additional controls to allow a similar threshold function to be applied for event count combination operation <B> as well.
      In one example, PMCACFGR is encoded as follows:

$$reserved [ 63 : 22 ] = RAZ$$

$$op < A > ACCTC [ 21 : 19 ]$$

$$op < A > CNTTC [ 18 : 16 ]$$

$$reserved [ 15 : 14 ] = RAZ$$

$$TrigEvent < B > [ 13 : 11 ]$$

$$TrigEvent < A > [ 10 : 8 ]$$

$$TrigCNTs < B > [ 7 : 4 ]$$

$$TrigCNTs < A > [ 3 : 0 ]$$

where these fields are interpreted as follows:
op<A>{ACC,CNT}TC[0]: count value passing threshold or threshold crossing test (similar to encoding of PMEVTYPER<i>.TC mentioned above).
   b0: count value above threshold
   b1: count threshold crossing
op<A>{ACC,CNT}TC[2:1]: type of comparison condition (similar to encoding of PMEVTYPER<i>.TC mentioned above). If met, count. If not met, do not update target.
   b00: Not-equal.
   b01: Equals.
   b10: Greater-than-or-equal.
   b11: Less-than.
TrigEvent<i>: trigger selected by PMCAopR.op<i>Trig=b10.
   b000: every clock cycle
   b001: on interface spurt events (these are events when the interface sees pending transactions and transports them under no or little backpressure).
   bx1x: reserved
   b1xx: reserved.
TrigCNTs<i>: selects which counters are used to define the trigger condition (this field may be a bitmap where each bit corresponding to a given counter 52, 54 and indicates whether or not that counter is one of the counters considered for the trigger rules defined in PMCAopR.op<i>Trig.
   PMCATHR<i>: Counter arithmetic threshold register for operation <i> (in the example of FIG. 4A, this is provided only for operation <A> but other examples could support threshold functions for more than one of the event count combination operations).
ACCTH [63:32]: defines threshold value for threshold function applied by circuitry 70 to result of event count combination operation.
CNTTH [31:0]: defines threshold value for threshold function applied by circuitry 62 to intermediate result of combining the non-derived event count values using circuitry 60.

FIG. 4B shows an algebraic representation of the event count combination operation <i> implemented by derived event count calculating circuitry 50 shown in FIG. 3, as configured by the control state described above.

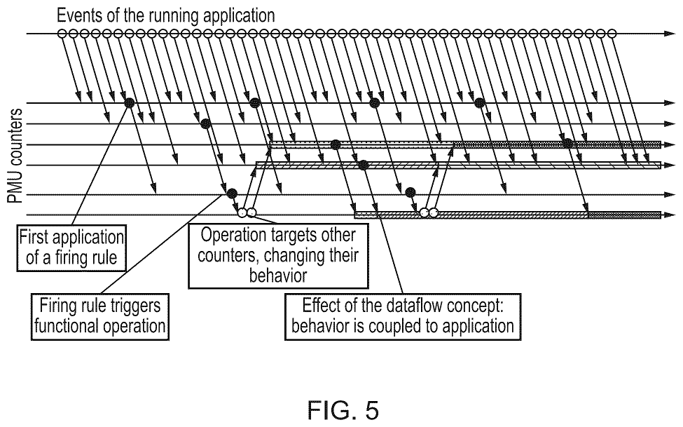

FIG. 5 illustrates the concept of performing event count combination operations according to a dataflow computation model. The dataflow concept is reflected in the examples above by the fact that trigger conditions are defined to control whether or not a given derived event counter 54 (event count accumulator register PMCAACCR<i>) is updated in a given cycle based on the result of the event count combination operation <i> determined in that cycle. As shown in FIG. 5, events occurring during execution of a given application trigger updates to corresponding non-derived event counters 52. Trigger conditions (or “firing rules”) can be defined so that an update to a given one of the counters 52 (or to each of a combination of counters) causes the trigger condition associated with a given derived event counter 54 to be satisfied, so that the derived event count calculating circuitry 50 updates the given derived event counter 54 based on a given event count combination operation. This derived event counter could itself be used for evaluating a trigger condition for further event count combination operations or counter updates. Hence, the operation of the performance monitoring circuitry can be seen as a “dataflow program” where each operation in the program is performed at a relative timing not defined in advance, but dependent on the actual events that occur for the application being executed. Hence, the monitoring can be coupled much more closely to the behaviour of the processing system while the application is being executed.

The performance monitoring circuitry 38 described above is therefore able to support a number of novel usage methods, which would not be possible with conventional performance monitoring circuitry that only comprises simple event counters with no ability to generate derived event count functions and no dataflow based trigger conditions. For example, these novel usage methods may include:
Competing metrics only during busy periods, to prevent that the averaging effect hides variations.
Obtaining worst-case measurements by taking the maximum over fluctuating counts 52 or derived metrics 54.
Obtaining estimations of distributions of measurements by varying a threshold on measured values.
Computing derived metrics as sums and differences of event counts and processing them according to the aforementioned usage models.
Building a latency profile.
Building a reuse distance profile.

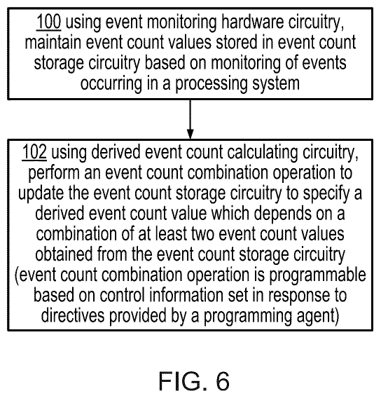

FIG. 6 illustrates steps for performance monitoring for a data processing system 2. At step 100, using event monitoring hardware circuitry 44, the performance monitoring circuitry 38 maintains event count values 52 stored in event count storage circuitry 46 based on monitoring of events occurring in the processing system 2. At step 102, using derived event count calculating circuitry 50 of the performance monitoring circuitry 38, an event count combination operation is performed to update the event count storage circuitry 46 to specify a derived event count value 54 which depends on a combination of at least two event count values 52, 54 obtained from the event count storage circuitry 46. The event count combination operation is programmable based on control information 42 set in response to directives issued by a programming agent. The derived event count calculating circuitry 50 is separate from a processor 4 of the processing system 2 being monitored.

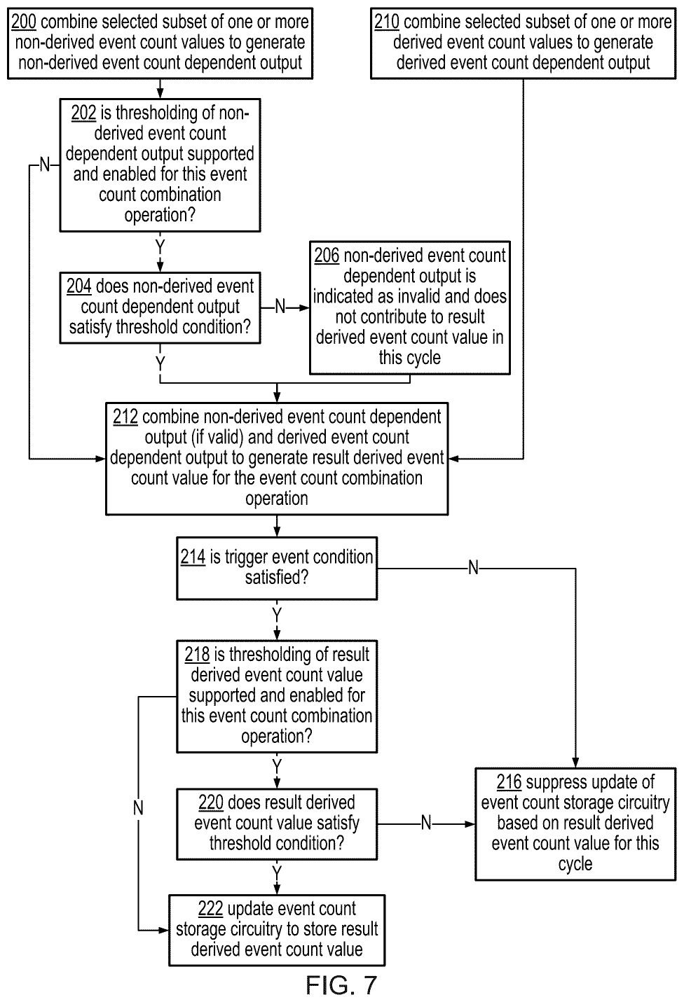

FIG. 7 illustrates a more detailed example of steps for performing an event count combination operation. At step 200, non-derived event count summation circuitry 60 combines (e.g. by addition or subtraction) a selected subset of one or more non-derived event count values 52 to generate a non-derived event count dependent output. The summation performed on the non-derived event count values 52 may be weighted by weight values defined by the addition weight controls PMCAopR.op<i>CNT<k>. The weight controls therefore effectively control the selection of which non-derived event count values 52 are combined, since any non-derived event count values 52 which are to be ignored can have the corresponding weight controls set to select a zero weight value. The weight controls also select whether a given non-derived event count contributes to the sum by addition or subtraction (by selecting between +1 and −1 weights).

If it is determined, at step 202, that thresholding of the non-derived event count dependent output is supported and is currently enabled for this event count combination operation (e.g. whether the thresholding is enabled may depend on part of the control information 42), then at step 204 the thresholding circuitry 62 determines whether the non-derived event count dependent output determined at step 200 satisfies a threshold condition. The control information 42 may include threshold condition defining information (e.g. PMCACFGR.op<i>CNTTC and PMCATHR<i>.CNTTH as described above) which defines the threshold condition to be applied. If the threshold condition is not satisfied then at step 206, the non-derived event count dependent output is indicated as invalid and does not contribute to the result of the event count combination operation (referred to as the “result derived event count value”) in this cycle. If either the threshold condition is satisfied at step 204 or thresholding is either not supported for this event count combination operation or is determined to be disabled at step 202, then the non-derived event count dependent output generated at step 200 is indicated as valid and can contribute to the result derived event count value.

Meanwhile, at step 210, the derived event count summation circuitry 64 combines a selected subset of one or more derived event count values 54 (PMCAACCR<i>) to generate a derived event count dependent output. Again, weights defined by the control information 42, in particular by PMCAopR.op<i>ACC<j>, may select which particular derived event count values 54 are combined and whether those event count values are added or subtracted.

At step 212, the combining circuitry 66 combines, according to a given combination function, the non-derived event count dependent output from step 200 (if valid) and the derived event count dependent output from step 210, to generate a result derived event count value for the event count combination operation. The given combination function could, for example, be addition, subtraction, maximum or minimum. In the example of FIGS. 3, 4A and 4B, only addition and maximum functions are supported for the combination function. Selection of the given combination function is dependent on the control information 42, e.g. based on PMCAopR.op<i>SumMax in the example of FIGS. 4A and 4B.

At step 214, the trigger condition circuitry 68 determines whether a trigger event condition is satisfied in the current cycle. The trigger event is programmable based on the control information 42, which can vary which types of non-counter related events and/or which event counters 52, 54 are used to detect the trigger condition, and can also vary the particular way in which multiple events are combined to evaluate the trigger condition. If the trigger event condition is not satisfied, then at step 216 the trigger condition circuitry 68 suppresses an update of the event count storage circuitry based on the result derived event count value computed at step 212 for this processing cycle. Also, if thresholding of the result derived event count value is determined at step 218 to be both supported and enabled for this event count combination operation, then at step 220 the derived event count thresholding circuitry 70 determines whether the result derived event count value determined at step 212 satisfies a threshold condition (again, the threshold condition could be programmable based on the control information 42 as described earlier). If the trigger event condition is satisfied 214 and either thresholding is not supported or enabled (N at step 218) or the threshold condition is satisfied (Y at step 220), then at step 222 the event count storage circuitry 46 is updated to store the result derived event count value in the event count register corresponding to this event count combination operation. If the threshold condition is not satisfied (N at step 220), then again at step 216 the performance monitoring circuitry 38 suppresses the update of the event count storage 46 based on the result derived event count value.

Concepts described herein may be embodied in a system comprising at least one packaged chip. The performance monitoring circuitry 38 described earlier (e.g. core PMU 30 and/or system PMU 32) is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

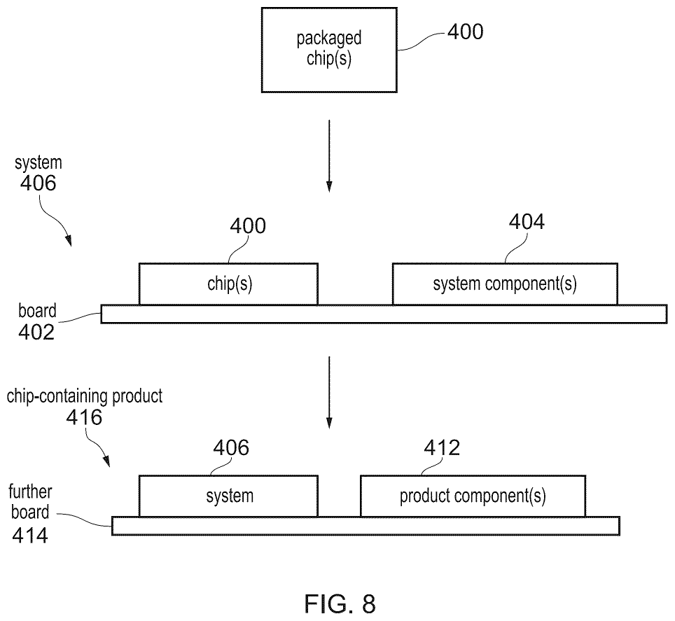

As shown in FIG. 8, one or more packaged chips 400, with the performance monitoring circuitry 38 described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the performance monitoring circuitry 38 described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. Performance monitoring circuitry for monitoring processing system performance; the performance monitoring circuitry comprising:
   event count storage circuitry to store a plurality of event count values;
   event monitoring hardware circuitry to maintain the event count values stored in the event count storage circuitry based on monitoring of events occurring in a processing system; and
   derived event count calculating circuitry to perform an event count combination operation to update the event count storage circuitry to specify a derived event count value which depends on a combination of at least two event count values obtained from the event count storage circuitry;
   wherein the event count combination operation performed by the derived event count metric calculating circuitry is programmable based on control information set in response to directives provided by a programming agent.
2. The performance monitoring circuitry of clause 1, wherein the derived event count calculating circuitry is programmable to enable a processor to delegate the event count combination operation to be performed by the derived event count calculating circuitry.
3. The performance monitoring circuitry according to any of clauses 1 and 2, in which the derived event count calculating circuitry is capable of performing the event count combination operation to update the event count storage circuitry to specify the derived event count value, even when all processors capable of instruction execution within the processing system are inactive.
4. The performance monitoring circuitry according to any of clauses 1 to 3, in which, for at least one setting of the control information, at least one of the at least two event count values on which the event count combination operation is performed is a previously derived event count value generated in a previous event count combination operation.
5. The performance monitoring circuitry according to any of clauses 1 to 4, in which the derived event count calculating circuitry is configured to perform the event count combination operation according to a dataflow computation model.
6. The performance monitoring circuitry according to any of clauses 1 to 5, in which, for at least one setting of the control information, the derived event count calculating circuitry is configured to determine whether a trigger event condition is satisfied, and in response to determining whether the trigger event condition is satisfied, trigger the update of the event count storage circuitry to specify the derived event count value.
7. The performance monitoring circuitry according to clause 6, in which, for at least one setting of the control information, the trigger event condition is dependent on occurrence of an update to at least one of the event count values.
8. The performance monitoring circuitry according to clause 7, in which, for at least one setting of the control information, the trigger event condition is dependent on any one of a plurality of event count values being updated.
9. The performance monitoring circuitry according to any of clauses 7 and 8, in which for at least one setting of the control information, the trigger event condition is dependent on a last event counter of a plurality of event count values being updated following previous updates being detected for each other of the plurality of event count values.
10. The performance monitoring circuitry according to any of clauses 7 to 9, in which for at least one setting of the control information, the trigger event condition is dependent on occurrence of at least one further non-event-count-dependent condition.
11. The performance monitoring circuitry according to any of clauses 1 to 10, in which for at least one setting of the control information, the derived event count calculating circuitry is configured to determine whether a result of the event count combination operation satisfies a threshold condition, and in response to determining that the result of the event count combination operation satisfies the threshold condition, trigger the update of the event count storage circuitry to specify the derived event count value.
12. The performance monitoring circuitry according to any of clauses 1 to 11, in which for at least one setting of the control information, the derived event count calculating circuitry is configured to determine whether a result of an intermediate step of the event count combination operation satisfies a threshold condition, and in response to determining that the result of the intermediate step of the event count combination operation satisfies the threshold condition, perform at least one further step of the event count combination operation dependent on the result of the intermediate step to generate the derived event count value.
13. The performance monitoring circuitry according to any of clauses 1 to 12, in which the event count combination operation comprises an arithmetic operation.
14. The performance monitoring circuitry according to any of clauses 1 to 13, in which, for at least one setting of the control information, the event count combination operation comprises addition or subtraction of the at least two event count values.
15. The performance monitoring circuitry according to any of clauses 1 to 14, in which for at least one setting of the control information, the event count combination operation comprises determining a maximum or minimum of the at least two event count values.
16. The performance monitoring circuitry according to any of clauses 1 to 15, in which the event count storage circuitry is configured to store a plurality of non-derived event count values maintained by the event monitoring hardware circuitry and one or more derived event count value generated by the derived event count calculating circuitry; and
   the derived event count calculating circuitry comprises:
      non-derived event count summation circuitry to perform addition or subtraction of at least a subset of the non-derived event count values to generate a non-derived event count dependent output; and
      combining circuitry to combine the non-derived event count dependent output with a derived event count dependent output dependent on at least a subset of the one or more derived event count values, to generate a result derived event count value corresponding to a result of the event count combination operation.
17. The performance monitoring circuitry according to any of clauses 1 to 16, in which, for at least one control setting, the event monitoring hardware circuitry is configured to monitor non-CPU events caused by an agent other than a central processing unit (CPU), and update at least one of the event count values depending on monitoring of the non-CPU events.
18. A system comprising:
   the performance monitoring circuitry according to any of clauses 1 to 17, implemented in at least one packaged chip;
   at least one system component; and
   a board,
wherein the at least one packaged chip and the at least one system component are assembled on the board.
19. A chip-containing product comprising the system of clause 18, wherein the system is assembled on a further board with at least one other product component.
20. A non-transitory computer-readable medium storing computer-readable code for fabrication of performance monitoring circuitry for monitoring processing system performance; the performance monitoring circuitry comprising:
   event count storage circuitry to store a plurality of event count values;
   event monitoring hardware circuitry to maintain the event count values stored in the event count storage circuitry based on monitoring of events occurring in a processing system; and
   derived event count calculating circuitry to perform an event count combination operation to update the event count storage circuitry to specify a derived event count value which depends on a combination of at least two event count values obtained from the event count storage circuitry;
   wherein the event count combination operation performed by the derived event count metric calculating circuitry is programmable based on control information set in response to directives provided by a programming agent.

21. A method for monitoring processing system performance, the method comprising:
using event monitoring hardware circuitry, maintaining a plurality of event count values stored in event count storage circuitry based on monitoring of events occurring in a processing system; and
using derived event count calculating circuitry, performing an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Performance monitoring circuitry for monitoring processing system performance; the performance monitoring circuitry comprising:
event count storage circuitry to store a plurality of event count values;
event monitoring hardware circuitry to maintain the event count values stored in the event count storage circuitry based on monitoring of events occurring in a processing system; and
derived event count calculating circuitry to perform an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

2. The performance monitoring circuitry of claim 1, wherein the derived event count calculating circuitry is programmable to enable a processor to delegate the event count combination operation to be performed by the derived event count calculating circuitry.

3. The performance monitoring circuitry according to claim 1, in which the derived event count calculating circuitry is capable of performing the event count combination operation to update the event count storage circuitry to specify the derived event count value, even when all processors capable of instruction execution within the processing system are inactive.

4. The performance monitoring circuitry according to claim 1, in which, for at least one setting of the control information, at least one of the at least two event count values on which the event count combination operation is performed is a previously derived event count value generated in a previous event count combination operation.

5. The performance monitoring circuitry according to claim 1, in which the derived event count calculating circuitry is configured to perform the event count combination operation according to a dataflow computation model.

6. The performance monitoring circuitry according to claim 1, in which, for at least one setting of the control information, the derived event count calculating circuitry is configured to determine whether a trigger event condition is satisfied, and in response to determining whether the trigger event condition is satisfied, trigger the update of the event count storage circuitry to specify the derived event count value.

7. The performance monitoring circuitry according to claim 6, in which, for at least one setting of the control information, the trigger event condition is dependent on occurrence of an update to at least one of the event count values.

8. The performance monitoring circuitry according to claim 7, in which, for at least one setting of the control information, the trigger event condition is dependent on any one of a plurality of event count values being updated.

9. The performance monitoring circuitry according to claim 7, in which for at least one setting of the control information, the trigger event condition is dependent on a last event counter of a plurality of event count values being updated following previous updates being detected for each other of the plurality of event count values.

10. The performance monitoring circuitry according to claim 7, in which for at least one setting of the control information, the trigger event condition is dependent on occurrence of at least one further non-event-count-dependent condition.

11. The performance monitoring circuitry according to claim 1, in which for at least one setting of the control information, the derived event count calculating circuitry is configured to determine whether a result of the event count combination operation satisfies a threshold condition, and in response to determining that the result of the event count combination operation satisfies the threshold condition, trigger the update of the event count storage circuitry to specify the derived event count value.

12. The performance monitoring circuitry according to claim 1, in which the event count combination operation comprises an arithmetic operation.

13. The performance monitoring circuitry according to claim 1, in which, for at least one setting of the control information, the event count combination operation comprises addition or subtraction of the at least two event count values.

14. The performance monitoring circuitry according to claim 1, in which for at least one setting of the control information, the event count combination operation comprises determining a maximum or minimum of the at least two event count values.

15. The performance monitoring circuitry according to claim 1, in which the event count storage circuitry is configured to store a plurality of non-derived event count values maintained by the event monitoring hardware circuitry and one or more derived event count value generated by the derived event count calculating circuitry; and
the derived event count calculating circuitry comprises:
non-derived event count summation circuitry to perform addition or subtraction of at least a subset of the non-derived event count values to generate a non-derived event count dependent output; and
combining circuitry to combine the non-derived event count dependent output with a derived event count dependent output dependent on at least a subset of the one or more derived event count values, to generate a result derived event count value corresponding to a result of the event count combination operation.

16. The performance monitoring circuitry according to claim 1, in which, for at least one control setting, the event monitoring hardware circuitry is configured to monitor non-CPU events caused by an agent other than a central processing unit (CPU), and update at least one of the event count values depending on monitoring of the non-CPU events.

17. A system comprising:
the performance monitoring circuitry according to claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of performance monitoring circuitry for monitoring processing system performance; the performance monitoring circuitry comprising:
event count storage circuitry to store a plurality of event count values;
event monitoring hardware circuitry to maintain the event count values stored in the event count storage circuitry based on monitoring of events occurring in a processing system; and
derived event count calculating circuitry to perform an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.

20. A method for monitoring processing system performance, the method comprising:
using event monitoring hardware circuitry, maintaining a plurality of event count values stored in event count storage circuitry based on monitoring of events occurring in a processing system; and
using derived event count calculating circuitry, performing an event count combination operation to update the event count storage circuitry to specify a derived event count value which depends on a combination of at least two event count values obtained from the event count storage circuitry;
wherein the event count combination operation performed by the derived event count metric calculating circuitry is programmable based on control information set in response to directives provided by a programming agent.
